(19) United States
(12) Patent Application Publication
(10) Pub. No.: US 2025/0357589 A1
(43) Pub. Date: Nov. 20, 2025

(54) Battery Cell Retention System

(71) Applicant: Lithos Energy, Inc., San Rafael, CA (US)

(72) Inventors: Robert Sweney, Oakland, CA (US); Colin Haag, Columbus, OH (US); Dennis Lauguico, Burnaby (CA); James Meredith, Mill Valley, CA (US)

(21) Appl. No.: 18/663,926

(22) Filed: May 14, 2024

(51) Int. Cl. H01M 50/204; H01M 50/289

(52) U.S. Cl. CPC H01M 50/204; H01M 50/289

(57) ABSTRACT

A device is disclosed. The device is a battery module frame. The battery module frame includes a rigid top integrated with an enclosure which surrounds a cavity into which a battery cell fits. The enclosure includes a compliant portion which forms a flex wall. The flex wall flexes to apply a radial load on a battery cell installed in the enclosure. The radial load applied by the flex wall secures the battery cell in the enclosure. The rigid top maintains the top of a battery cell installed in the battery cell holding frame in a stationary position to maintain electrical connections on the battery cells. The device further includes a frame of multiple enclosures defining multiple cell cavities for holding battery cells. The rigid top maintains the top of each battery cell installed in the frame in a stationary position to maintain electrical connections on the battery cells.

### TECHNICAL FIELD

This disclosure relates to mechanical retention of individual cylindrical cells in a battery module. The disclosure further relates to position control and tolerance absorption of individual cylindrical cells in a battery module.

### BACKGROUND

A battery module is a group of individual battery cells that are electrically connected and encased in a housing. They are the building blocks of larger battery packs, which are used in a wide variety of applications, from electronics and power tools to electric vehicles and grid storage. Frames are used to organize the battery cells and hold them in place. Frames also provide the scaffolding for the electrical connection between the battery cells.

### SUMMARY

In a first aspect, the disclosure provides a device. The device is a battery module frame. The battery module frame includes a rigid top integrated with an enclosure which surrounds a cavity into which a battery cell fits. The enclosure includes a compliant portion which forms a flex wall. The flex wall flexes to apply a radial load on a battery cell installed in the enclosure. The radial load applied by the flex wall secures the battery cell in the enclosure. The rigid top maintains the top of a battery cell installed in the battery cell holding frame in a stationary position to maintain electrical connections on the battery cells.

The enclosure of the battery cell holding frame may include multiple walls. In some implementations, the multiple walls of the battery cell holding frame are six walls. In some of these implementations, the six walls comprise a regular hexagon.

The frame is designed to hold battery cells. The cells need to be installed into the battery cell holding frame. Features of the frame assist in this installation. In some implementations, a notch in one wall allows the battery cell to be inserted into the battery cell holding frame in a less than perfect orientation. In some implementations, the notch is positioned in the flex wall. In some implementations, the crush ribs are tapered. In some implementations, the battery cell holding frame is designed to accommodate battery cells of varying diameters and circumference. In some implementations, the flex wall is tuned to apply an appropriate radial load against the battery cell.

The battery cell holding frames are designed to be able be arranged in multiple configurations. In some implementations, multiple battery cell holding frames are arranged in a row. In some implementations, the battery cell holding frames are arranged into a battery module frame comprising multiple battery cell holding frames in multiple rows. In some implementations, each row of multiple battery cell holding frames of the battery module frame comprises between three and twelve battery cell holding frames, and wherein the battery module frame comprises between three and twelve rows. In some implementations, each row of multiple battery cell holding frames of the battery module frame comprises eight battery cell holding frames, and wherein the battery module frame comprises eight rows.

The battery module frame holds the battery cells in a fixed position to maintain electrical connections on the battery cells. The battery module frame comprises an upper portion and a lower portion. The upper portion of the battery module frame holds the top of each battery cell in a fixed position to maintain electrical connections on the battery cells.

In a second aspect, the disclosure provides a device. The device includes a frame of multiple enclosures defining multiple cell cavities for holding battery cells. Each enclosure includes a rigid top integrated with the multiple enclosures. A portion of each enclosure being compliant and forming a flex wall which flexes to apply a radial load on a battery cell installed in each enclosure. The radial load applied by the flex wall secures each battery cell in each enclosure. The rigid top maintains the top of each battery cell installed in the frame in a stationary position to maintain electrical connections on the battery cells.

In some implementations, the frame comprises an upper portion defining a first set of enclosures and a lower portion defining a second set of enclosures, and the first set of enclosures of the lower portion correspond to the second set of enclosures in the upper portion. In some implementations, the first set of enclosures defined by the upper portion of the frame includes the flex wall and the rigid top which combine to hold the top of each battery cell in place.

In some implementations, the upper portion further comprises electrical connections between the battery cells.

Further aspects and implementations are provided in the foregoing drawings, detailed description, and claims.

### BRIEF DESCRIPTION OF THE DRAWINGS

The following drawings are provided to illustrate certain implementations described herein. The drawings are merely illustrative and are not intended to limit the scope of claimed inventions and are not intended to show every potential feature or implementation of the claimed inventions. The drawings are not necessarily drawn to scale; in some instances, certain elements of the drawing may be enlarged with respect to other elements of the drawing for purposes of illustration.

FIG. 1 is a bottom-up view of a multicell frame for holding battery cells.

FIG. 2 is an isometric view of the top portion of the frame from the bottom of the frame.

FIG. 3 is a cross-section view showing one of the crush ribs in each battery cell cavity.

FIG. 4 is a bottom-up view of the upper portion of the modular frame with the battery cells installed.

FIG. 5 is a top-down isometric view of the multi-cell frame.

FIG. 6 is a top-down isometric view of the top portion of the multi-cell frame installed with the bottom portion of the multi-cell frame.

FIG. 7 is a top-down isometric view of the multi-cell frame with the battery cells installed in the battery cell cavities.

FIG. 8 is a top-down view of the upper portion of the modular frame with the battery cells installed in the battery cell cavities.

### DETAILED DESCRIPTION

The following description recites various aspects and implementations of the inventions disclosed herein. No particular implementation is intended to define the scope of the invention. Rather, the implementations provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding implementations illustrated in the present disclosure and are not meant to be limiting in any fashion. Nor do these phrases indicate any kind of preference for the disclosed implementation.

As used herein, “battery” is meant to refer to a device that stores chemical energy and converts it into electrical energy. A battery is made up of one or more electrochemical cells that use chemical reactions to produce electricity.

As used herein, “battery module” is meant to refer to a group of two or more individual battery cells that are electrically connected together and encased in a housing. Battery modules are the building blocks of larger battery packs, which are used in a wide variety of applications, from electronics and power tools to electric vehicles and grid storage.

As used herein “regular shape” is meant to refer to a shape or a polygon in which all the sides are of equal length, and all the interior angles are equal. For example, a regular hexagon has six sides of equal lengths, and the interior angles are all one hundred and twenty degrees (120°).

Battery cells are grouped into modules for several reasons. One reason is to improve safety. By grouping the cells together, it is easier to contain any leakage of electrolyte. Additionally, any fire will be isolated to a smaller group. Further, modules can be equipped with sensors and controls that can help to prevent safety hazards. Another reason to group cells into modules is to improve efficiency. By connecting the cells in series, the voltage of the battery pack can be increased. By connecting the cells in parallel, the capacity of the battery pack can be increased. This allows battery packs to be tailored to the specific needs of an application. Grouping cells into modules can make them easier to manufacture and assemble. Modules can be pre-assembled and tested before being integrated into a larger battery pack. This can help to improve the quality and reliability of battery packs.

Battery cells are often cylindrical in shape. Cylindrical shapes for batteries offer some advantages including good mechanical stability and ease of manufacture. The cylindrical shape distributes pressure evenly throughout the cell. This makes them structurally strong and able to withstand the buildup of internal pressure during operation. This is important for safety, as it reduces the risk of leaks or ruptures. Cylindrical cells are relatively simple to manufacture using automated processes. This makes them a cost-effective option, especially for mass production. The winding process for the electrodes within the cell is well-established and allows for consistent quality. The cylindrical shape allows for better air circulation around the cell, which helps to keep it cool. This is important because heat can degrade battery performance and lifespan. Cylindrical cells can better handle swelling caused by gas buildup during charging and discharging cycles.

However, disadvantages of cylinders include the necessity to provide a frame or scaffold to hold the cylinders because a cylinder is less stable when positioned next to other cylinders. Most battery pack designs, and particularly those designed for cylindrical battery cells utilize adhesives or mechanical retention devices which are located away from the top of the battery cell, where the electrodes are generally positioned. Both of these options are less than ideal. Adhesives are heavy, expensive, hard to control, and often have a slow cure time. All these detriments to adhesives affect the speed at which a battery pack is assembled. Mechanical retention away from the top of the cell, offers less mechanical rigidity to the top of the cell, which is detrimental because most of the electrical connections attach at the top of the cell, where the electrodes are positioned, if the battery cells are not held rigidly in place connections between the cells can be difficult to establish, or can be broken if the cells shift.

A frame can be used to hold the battery cells in place. Each battery cell will require its own frame. Each frame is constructed of a rigid top integrated with an enclosure which surrounds a cavity into which a battery cell fits. In some implementations, the enclosure is cylindrical. In some implementations, the enclosure includes multiple walls, the multiple walls may include any number of walls. In some implementations, the frame has between three and ten side walls. In some of these implementations, the side walls are of equal lengths on the horizontal axis, creating regular shapes or regular polygons. In some implementations, the side walls are of different lengths on the horizontal axis. In some implementations, the frame may extend the full length of the battery cell. In some other implementations, the frame may be in two portions, an upper portion which encompasses and supports the top of a battery cell and a lower portion which encompasses and supports the bottom of the battery cell. In these implementations, the upper portion may be between one fourth the length of the battery cell and one half the length of the battery cell. In other implementations, the upper portion may be one third the length of the battery cells.

To fully secure each battery cell in an individual battery cell frame, each frame includes features to hold the battery cells in place. A rigid top prevents the enclosure of the frame from moving. This rigid top is important for preventing the top of the battery cells from shifting. The electrodes of the battery cells are located at the top of the battery, and the electrical connections attach at the top. The rigid top of the frame enables the electrical connections to be maintained on the battery cells. Another feature to secure each battery cell in place is a flex wall. The flex wall is a compliant portion of the enclosure, or a flex wall. In embodiments with cylindrical or near cylindrical enclosures, the flex wall is a protrusion which juts into the cavity surrounded by the enclosure. The flex wall flexes to accommodate a battery cell. In implementations with multiple walls, the flex wall arcs between two side walls adjacent to the flex wall. The arc causes the flex wall to push on the side of the battery cell, thus imparting a radial load on the battery cell. In some implementations, the flex wall may be attached to a single adjacent side wall and form an incomplete arc. In some implementations, the enclosure includes multiple flex walls. In addition to the flex wall, each individual frame includes at least one stationary contact point. In most implementations, the stationary contact point is a crush rib. There may be multiple crush ribs to have multiple stationary contact points. The crush ribs protrude from the side walls and run a substantial distance down the side walls. In most implementations, with multiple side walls, each crush rib is positioned in the center of the side wall on which it is located. In some implementations, each crush rib is positioned nearer one adjacent side wall. The flex wall pushes the battery cell into the crush ribs. The crush ribs are located on the side walls of the frame to create at least three points of contact for the battery cell. To create even holding ability, in some implementations, the crush ribs are located between one hundred and one hundred and forty degrees from the center of the flex wall. In some implementations, the crush ribs are located one hundred and twenty degrees from the center of the flex wall. In some implementations, the crush ribs are on walls adjacent to the flex wall. In some implementations, there is at least one wall between the flex wall and the wall with the crush ribs. In some implementations, the crush ribs are on two side walls. In some implementations, the crush ribs are on more than two side walls. In some implementations, slots are used in place of the crush ribs. The slots may be indentations in the side walls that can assist in holding the battery cell in place.

Each individual battery cell frame includes features designed to assist in the installation of each battery cell into the individual cell frame. These features enable each battery cell to be inserted into the individual battery cell frame in less-than-ideal orientations. Less-than-ideal orientations include battery cells that are not perfectly aligned with the cell cavity of the individual battery cell frame on a horizontal axis, and battery cells that are not perfectly aligned vertically with the walls of the individual battery cell frame. One such feature is a notch in one of the side walls. In some implementations, the notch is in a side wall. In some implementations, the notch is in the flex wall. In some implementations, the notch is U-shaped. In some implementations, the notch is V-shaped. The notch may be of a variety of depths. The notch accommodates misaligned battery cells to enable the battery cell to be inserted into the battery cell frame in a less than ideal orientation. In practice, a battery cell may extend over the notch and as the battery cell is inserted into the battery cell frame, the notch will lead the battery cell into the proper alignment. A battery cell may also be initially inserted in a manner that the side of the battery cell is not aligned vertically with the side walls of the frame, the notch enables the battery cell to be inserted and lead into a proper vertical alignment with the side walls of the frame. A second feature that assists in the installation of battery cells into the battery cell frame is the tapered ends of the crush ribs. The ends of the crush ribs are tapered so as not to be an abrupt shelf on which the battery cell can catch when the battery cell is being installed. The taper may be in one or multiple planes. In some implementations, the taper is a ramp with a single plane angling from one end of a crush rib. In other implementations, the taper is cone shaped. In yet other implementations, the taper is a rounded cone shape. The crush ribs protrude from the side walls of the battery cell frame which creates space between the location in which the battery cell is held and the side walls of the battery cell frame. This space can be utilized upon inserting the battery cell into the battery cell frame. The battery cell extends over the space between the side walls of the battery frame and the crush ribs, as the battery cell is pushed into the frame, the taper of the crush ribs will lead the battery cell into the location in which the battery cell is held. In practice the battery cell can be initially inserted over a larger area, and the taper of the crush ribs will align the battery cell into its final location.

Each battery cell is inserted into the battery cell frame. As each battery cell is initially inserted, the battery cell will be positioned so that the battery cell will slide directly into the battery cell frame, or the battery cell will be positioned so that the notch in the flex wall or the taper of the crush ribs will lead the battery cell into its proper alignment. When the battery cell is fully inserted, the flex wall exerts a radial load on the battery cell to push the battery cell into the crush ribs. Together the flex wall and the crush ribs hold the battery cell in place. Holding the battery cell in place is especially important for the top of the battery cell. In some implementations, the battery cell is inserted top first. The top of the battery cell is where the electrodes for the battery cell and where electrical connections for each battery cell are made. By holding the battery cell, especially the top of the battery cell, in place, or holding the top of the battery cell rigid, the electrical connections remain in place, or are maintained, and are less likely to be damaged.

The frames may be arranged in rows to create a multicell frame. In some implementations, the frames may be arranged in rows of between three and twelve battery cell holding frames. In some implementations, the rows are further arranged into multiple rows to create a battery module frame. In some implementations, the battery cell holding frames may be arranged between three rows and twelve rows. In some implementations, a battery module may be arranged from three rows of three frames to twelve rows of twelve frames. In some implementations, a battery module is arranged in eight rows of eight battery cell holding frames. The battery modules may further be arranged so that there is a front module, a middle module, and a rear module. The modules may be combined in any number of modules to create a battery pack of any size.

### Examples

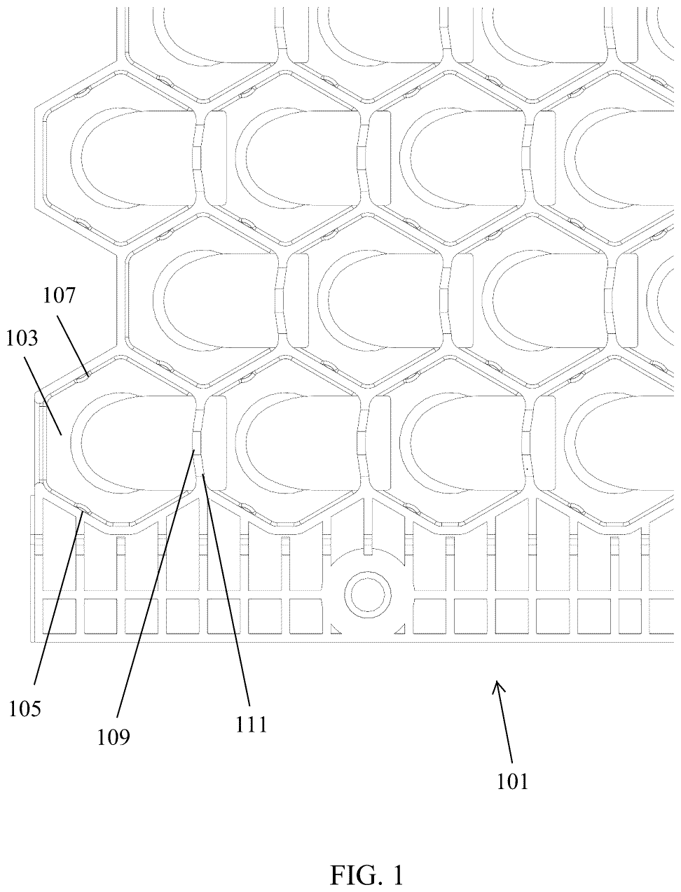

Now referring to FIG. 1, which is a bottom-up view of a multicell frame 101 for holding battery cells. The frame includes individual battery cell holding frames which form battery cell cavities, such as cavity 103 for holding battery cells. The individual cell frames are connected together to form the multicell frame, as each individual battery cell holding frame defines a cavity, the multicell frame defines multiple cell cavities. Each frame has multiple walls to define the battery cell cavity, in the frame depicted in FIG. 1, the individual cell frame has six walls. In this implementation, the length of each wall is the same length, creating a regular hexagon shaped cell frame. One advantage of hexagonal cell frames is the ability of the hexagons to stack, and to have all the cell frames be identically oriented. Two of the side walls include crush ribs, such as crush ribs 105 and 107, and one wall is a flex wall such as flex wall 109. The crush ribs are positioned so that they are on side walls with one wall between the side walls on which the crush ribs are positioned and the flex wall. The crush ribs are positioned about one hundred and twenty degrees from the center of the flex wall. The flex wall is designed to impart a radial force on a battery cell placed in the cell cavity. The flex wall arcs from one of the side walls adjacent to the flex wall to the other side wall adjacent to the flex wall. The flex wall can be tuned to provide sufficient force on the battery cell. In addition to flexing to accommodate a battery cell, the flex wall includes a notch in the wall, such as notch 111. This notch allows battery cells to be pushed into the cell cavity without the cell being perfectly positioned to enter the cavity. In practice this means that a battery cell could be misaligned relative to either the horizontal or to the vertical orientation of the cell cavity and the battery cell will still slide into the cavity without becoming hung up on the bottom edge of the flex wall of the individual cell frame.

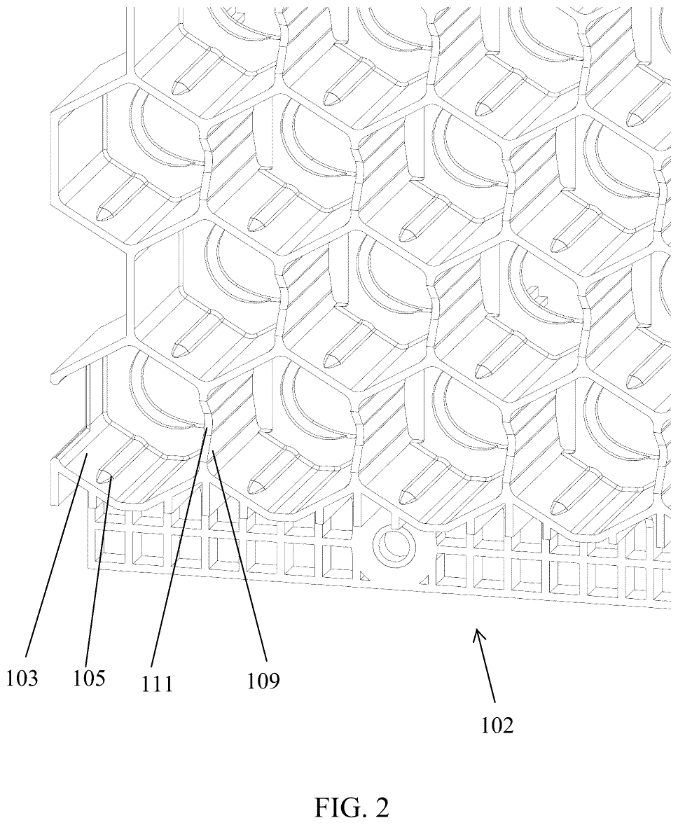

Referring now to FIG. 2 which is an isometric view of the top portion 102 of the frame from the bottom of the frame. The frame includes multiple individual cell frames which define individual cell cavities, such as cell cavity 103. Each frame includes six walls. Two of the walls include crush ribs such as crush rib 105. The other crush rib is located on another wall and there is one wall between the walls with the crush ribs. The crush ribs, such as crush rib 105 are designed with a taper. The taper is pointed down, or toward the direction in which the battery cells are inserted into the cell cavity. The crush ribs assist in holding the battery cell in place. The taper on the crush ribs assists in getting the battery cell in place. The taper of the crush ribs also allows the battery cell to be inserted in a less than perfect orientation without getting hung up on the crush ribs. In addition to the taper of the crush ribs, the notches, such as notch 111 in the flex walls, such as flex wall 109 allow the battery cells to be inserted in less than perfect orientation. These features allow the battery cells to be inserted in less than perfect orientation, this can mean that the battery cells are not perfectly oriented with the battery cell cavities. This less than perfect orientation can be in the horizontal axis where the battery cell is aligned closer to one wall instead of directly through the middle of the cell cavity. This less than perfect orientation can also be in the vertical axis where the battery cell is not perfectly aligned vertically with the side walls of the frame. For example, the walls of the battery cell frame can be thought of as at zero degrees, the battery cell can be inserted starting at up to ten degrees off from the alignment with the walls of the battery cell frame.

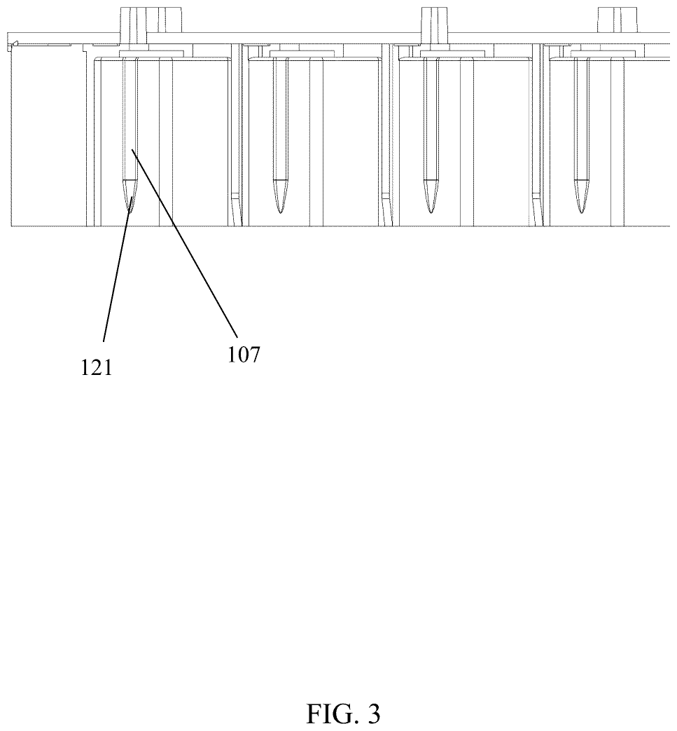

FIG. 3 is a cross-section view showing one of the crush ribs on one side wall of each battery cell frame. Each battery cell frame includes two crush ribs. The crush ribs are positioned one wall away from each other and one wall away from the flex wall. The crush ribs, such as crush rib 107 act in concert with the flex wall to hold the battery cells in place in the battery cell cavities. The crush ribs, such as crush rib 107 include a taper, such as taper 121. The taper on the crush ribs assists in getting the battery cell in place. The taper of the crush ribs also allows the battery cell to be inserted in a less than perfect orientation without getting hung up on the crush ribs.

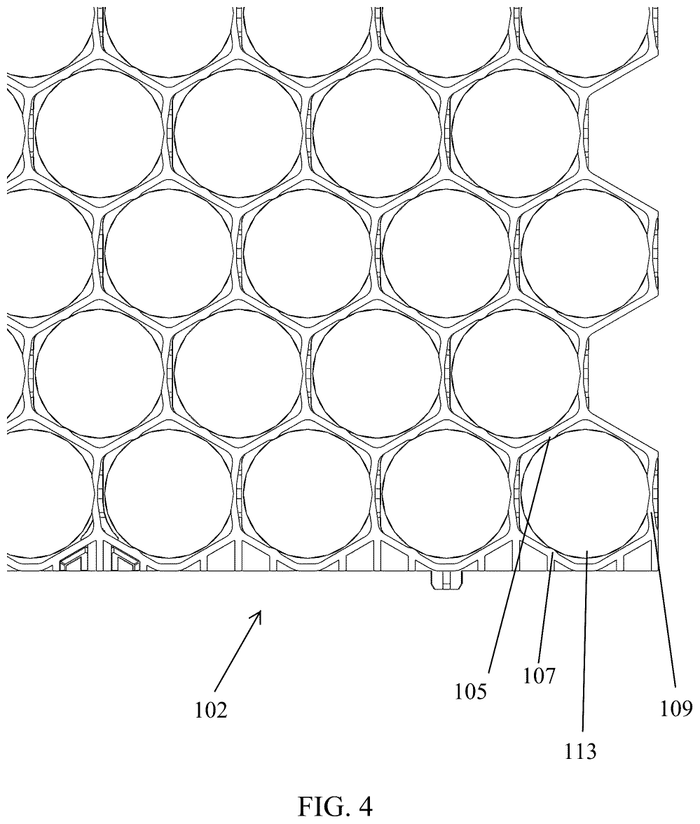

FIG. 4 is a bottom-up view of the upper portion 102 of the modular frame with the battery cells installed. Each battery cell such as battery cell 113 is held in place by the flex walls, such as flex wall 109. The flex walls exert a radial load on the battery cells, and push the battery cells, such as battery cell 113, into the crush ribs, such as crush ribs 105 and 107. The battery cell cavities are larger than the diameter of the battery cells. The battery cell cavities being larger than the battery cells accommodate the flex walls of neighboring rows of battery cell frames. The flex walls and the crush ribs allow battery cells that are larger or smaller than the nominal size of the battery cells to be accommodated. The flex walls will push the battery cells smaller than the nominal diameter into the crush ribs, taking up the space that would have been taken by the missing volume of the smaller battery cell. The flex wall will also flex outward to allow battery cells larger than the nominal diameter to fit within the battery cell cavities. The ability of the battery cell frames to accommodate a wide range of battery cell diameters assists in faster assembly. Those battery cells with a diameter larger than nominal will still fit within the battery cell frames and insertion of the cells will not be hindered. Additionally, the ability to rigidly retain battery cells with diameters smaller than nominal assists by reducing or removing the possibility that a battery cell could fall out of place thus slowing or stopping the manufacture of multi cell battery production.

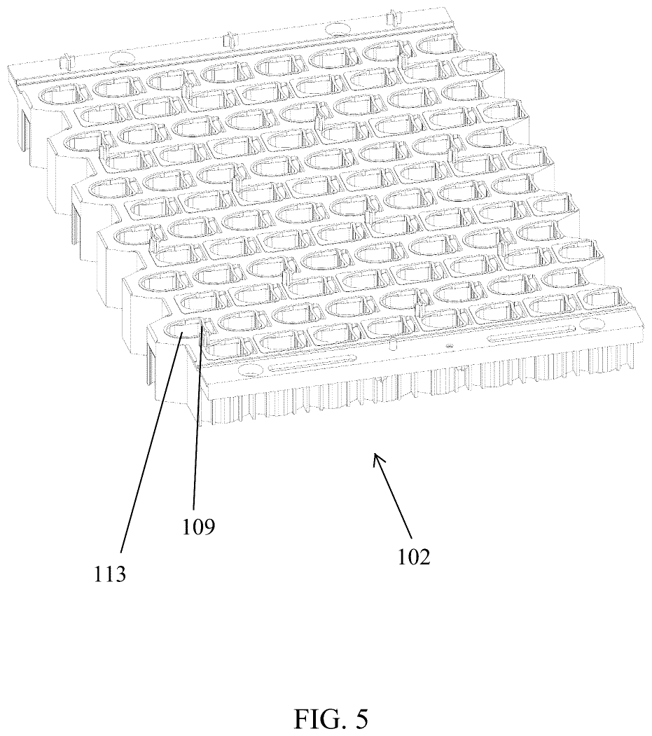

Referring now to FIG. 5 which is a top-down isometric view of the multi-cell frame. The top portion of the frame 102 includes channels on the top surface for electrical connections to the electrodes of the batteries. The top of each cell cavity in the frame includes an opening, such as opening 113 to allow access to the top of the battery cell. The flex walls such as flex wall 109 are visible. The arc of the flex wall 109 enables the flex wall to impart a radial force on the battery cells to hold the battery cells in place.

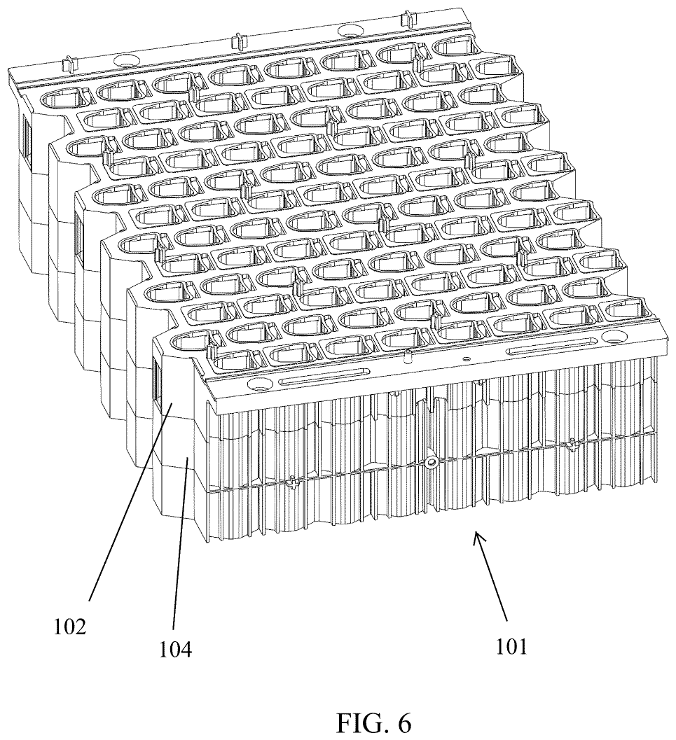

Referring to FIG. 6 which is a top-down isometric view of the top portion 102 of the multi-cell frame 101 installed with the bottom portion 104 of the multi-cell frame 101. The bottom portion of the modular frame includes cell cavities defined by the individual cell frames which correspond to the cell cavities defined by the individual cell frames in the upper portion. The top portion of the frame is one third the height of the combined frame. When the battery cells are installed in the upper portion of the frame, the upper portion of the frame encloses the top third of the battery cells. The top portion of the modular frame needs to be strong enough to hold the top of the battery cells rigid, and simultaneously needs to be able to be made flexible enough so that the flex wall can flex and provide a radial load on the battery cells. Additionally, it is beneficial to construct the top portion as a single piece, therefore the top portion needs to be constructed of a material that can be manufactured in a single piece. The bottom portion is also constructed in a single piece. In some implementations, the top portion and bottom portion are both made from plastic. In some implementations, the top portion and the bottom portion are made from a composite material. In some implementations, the top portion is made from a different material than the bottom portion.

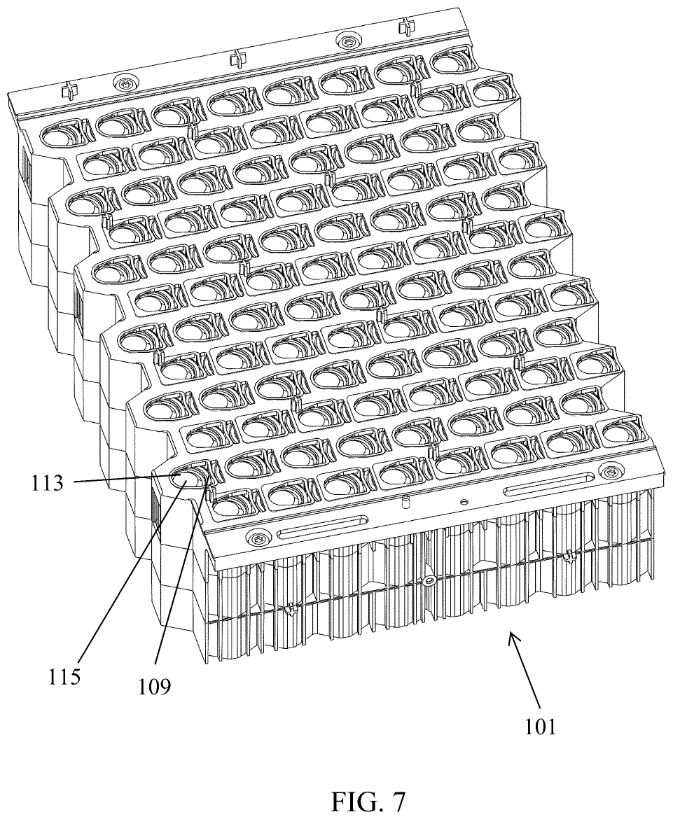

Referring to FIG. 7 which is a top-down isometric view of the multi-cell frame 101 with the battery cells installed in the battery cell cavities. The top of each battery cell cavity includes an opening, such as opening 113, through which the top of each of the battery cells, such as battery cell 115, is accessible. The battery cell pushes up against the top of the frame. The flex walls such as flex wall 109 impart a radial load on the side of the battery cells.

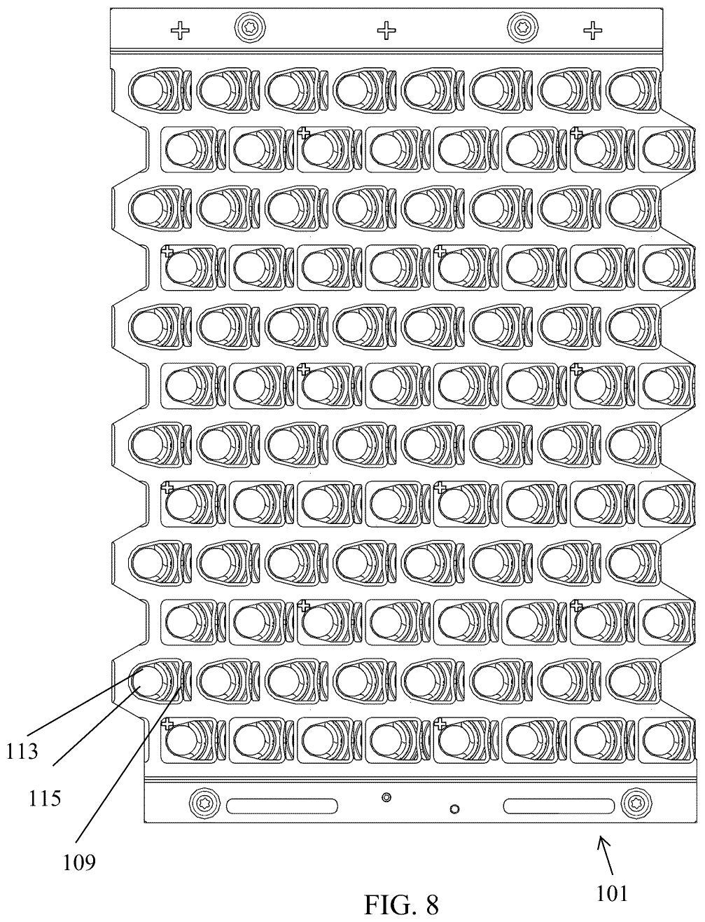

FIG. 8 is a top-down view of the modular frame 101 with the battery cells installed in the battery cell cavities. The top portion of the frame includes openings, such as opening 113 through which the top of each of the battery cells, such as battery cell 115, are accessible. The flex walls such as flex wall 109 impart a radial load on the side of the battery cells.

The invention has been described with reference to various specific and preferred implementations and techniques. Nevertheless, it is understood that many variations and modifications may be made while remaining within the spirit and scope of the invention.

What is claimed is:

1. A device comprising:
a battery cell holding frame comprising:
a rigid top integrated with an enclosure which enclosure surrounds a cavity into which a battery cell fits, the enclosure comprising;
a compliant portion which forms a flex wall which flexes to apply a radial load on a battery cell installed in the enclosure;
wherein the radial load applied by the flex wall secures the battery cell in the enclosure; and
wherein the rigid top maintains a top of a battery cell installed in the battery cell holding frame in a stationary position to maintain electrical connections on the battery cells.

2. The device of claim 1, wherein the enclosure comprises multiple walls.

3. The device of claim 2, wherein the multiple walls of the enclosure comprise six walls.

4. The device of claim 3, wherein the six walls comprise a regular hexagon.

5. The device of claim 1, further comprising a notch in one wall to allow the battery cell to be inserted into the enclosure of the battery cell holding frame in a less than perfect orientation.

6. The device of claim 5, wherein the notch is positioned in the flex wall.

7. The device of claim 6, further comprising at least one stationary contact point.

8. The device of claim 7, wherein the at least one stationary contact point is a tapered crush rib.

9. The device of claim 8, wherein the battery cell holding frame is designed to accommodate battery cells of varying diameters and circumferences.

10. The device of claim 1, wherein the flex wall is tuned to apply an appropriate radial load against the battery cell.

11. The device of claim 1, further comprising multiple battery cell holding frames arranged in a row.

12. The device of claim 11, further comprising a battery cell holding frame module comprising multiple battery cell holding frames in multiple rows.

13. The device of claim 12, wherein each row of multiple battery cell holding frames of the battery cell holding frame module comprises between three and twelve battery cell holding frames, and wherein the battery module frame comprises between three and twelve rows.

14. The device of claim 13, wherein each row of multiple battery cell holding frames of the battery cell holding frame module comprises eight battery cell holding frames, and wherein the battery module frame comprises twelve rows.

15. The device of claim 12, wherein the battery cell holding frame module comprises an upper portion and a lower portion.

16. The device of claim 15, wherein the upper portion of the battery cell holding frame module holds a top of each battery cell in a fixed position to maintain electrical connections on the battery cells.

17. A device comprising:
a frame of multiple enclosures defining multiple cell cavities for holding battery cells, each enclosure comprising:
a rigid top integrated with the multiple enclosures;
a portion of each enclosure being compliant and forming a flex wall which flexes to apply a radial load on a battery cell installed in each enclosure;
wherein the radial load applied by the flex wall secures each battery cell in each enclosure; and
wherein the rigid top maintains the a of each battery cell installed in the frame in a stationary position to maintain electrical connections on the battery cells.

18. The device of claim 17, wherein the frame comprises an upper portion defining a first set of enclosures and a lower portion defining a second set of enclosures, wherein the second set of enclosures of the lower portion correspond to the first set of enclosures in the upper portion.

19. The device of claim 18, wherein each set of enclosures of the upper portion of the frame includes the flex wall and the rigid top which combine to hold the top of each battery cell in place.

20. The device of claim 19, wherein the upper portion further comprises electrical connections between the battery cells.
